(19) United States
(12) Patent Application Publication
(10) Pub. No.: US 2019/0166889 A1
(43) Pub. Date: Jun. 6, 2019

(54) Roasting Method For Meat Based On Temperature

(71) Applicant: Institute of Food Science and Technology,Chinese Academy of Agricultural Sciences, Beijing (CN)

(72) Inventors: Dequan ZHANG, Beijing (CN); Zhenyu WANG, Beijing (CN); Teng PAN, Beijing (CN); Xin LI, Beijing (CN); Chengli HOU, Beijing (CN); Li CHEN, Beijing (CN); Teng HUI, Beijing (CN); Xiaochun ZHENG, Beijing (CN)

(21) Appl. No.: 16/186,997

(22) Filed: Nov. 12, 2018

(30) Foreign Application Priority Data
Dec. 4, 2017 (CN) 201711259600X

(51) Int. Cl. A23L 5/10; A23L 13/70; A23B 4/07

(52) U.S. Cl. CPC A23L 5/15; A23V 2002/00; A23B 4/07; A23L 13/72

(57) ABSTRACT

The invention discloses a roasting method for meat based on temperature, including: cooking: cooking the pretreated raw meat to center temperature of 70-80 degree Celsius, and maintaining for 1-2 min; drying: performing drying treatment of the surface of the raw meal: after cooking treatment; roasting: roasting the dried raw meat to surface temperature of 110-120 degree Celsius and maintaining for 5-8 min. The inventive method uses the cooking center temperature and the roasting surface temperature as key control points of roast meat to facilitate on-line monitoring and automatic production, which is an economical and practical new roasting method. The roast meat prepared by the inventive method not only ensures color and flavor of traditional roasting method, but also shortens roasting time. The roasting method can be used for the industrial production of roast meat.

This application claims priority to Chinese Patent Application Ser. No. CN 201711259600X filed 4 Dec. 2017

### TECHNICAL FIELD

The present invention relates to the field of food processing, in particular to a roasting method for meat based on temperature.

### BACKGROUND

Traditional roasting method for meat used electric roasting or charcoal roasting with open flames. The roasting temperature and time vary widely. The roasting method for meat is difficult to achieve standardized roasting, resulting in uneven roasting of raw meat, low degree of roasting standardization, and high content of hazardous materials in the roasting process. For example, the electric roasting is prone to excessive local temperature, resulting in having cooked or burnt outside and raw inside, and uneven roasting. The charcoal roasting method has low heat transfer efficiency, which may cause long roasting time, large loss, loss of nutrients and increase of processing chemical hazards such as polycyclic aromatic hydrocarbons and heterocyclic amine compounds. With the development of industrialization and changes in the concept of healthy consumption, there have been methods such as roasting with electric oven, roasting with gas oven, and electric infrared roasting. These methods can achieve continuous roasting, and the roasting efficiency is slightly higher than traditional roasting. However, the temperature of the roasting process is difficult to monitor, and the roasting time cannot be standardized, resulting in serious loss of flavor of the roast meat and extremely extreme deterioration of the quality of the roasted product. New technological innovation is urgently needed.

The far-infrared convection oven consists of a quartz tube that emits radiation infrared ray and a convection air circulation system. The infrared ray is concentrated by a mirror, which coordinates the convection air circulation system for heating the food. Meat fat and muscle are mainly composed of organic polymers, low molecular and inorganic salts, moisture, etc., which have strong absorption ability to infrared. In theory, it is feasible to heat meat with radiation infrared ray. The far-infrared roasting new equipment can realize automatic temperature control and time control, which lays a foundation for automated mass production. However, how to set the roasting temperature and time, how to intelligently monitor it and energy-saving roast, we must optimize the optimal parameters of roasting, determine roasting method based on temperature, reduce the roasting time, improve the roasting efficiency, and maintain roasted flavor quality.

### DESCRIPTION

A purpose of the present invention is to solve at least above problems and to provide at least advantages that will be described later.

Another purpose of the present invention is to provide a roasting method for meat based on temperature, which realizes industrialization, standardization and digital roasting of meat, and ensures uniform quality of roast meat.

In view of purposes mentioned above and other advantages, the present invention provides a roasting method for meat based on temperature, including the following steps of:

cooking: cooking the pretreated raw meat to center temperature of 70-80 degree Celsius, and maintaining for 1-2 min;

drying: performing drying treatment of the surface of the raw meat after cooking treatment;

roasting: roasting the dried raw meat to a surface temperature of 110-120 degree Celsius and maintaining for 5-8 min.

Preferably, the pretreated raw meat is cooked to center temperature of 75 degree Celsius, and maintaining for 1 min.

Preferably, the roasting temperature is 200-260 degree Celsius, roasting dried raw meat to a surface temperature of 110-120 degree Celsius and maintaining for 5 min.

Preferably, the roasting temperature is 240 degree Celsius, roasting dried raw meat to a surface temperature of 115 degree Celsius and maintaining for 5 min.

Preferably, the method of the present invention may use any roasting method, preferably using a far-infrared light wave to roast the raw meat.

Preferably, the drying temperature of the cooked raw meat in the drying treatment is 25-70 degree Celsius, the weight of the meat being reduced by 1-3% and then maintaining for 1-3 min, so that there is no dripping water on the surface of the meat.

Preferably, the specific method of the pretreatment includes:

washing fresh raw meat or thawed raw meat with water to remove residual blood and dirt;

injecting 1 part of salt solution with mass fraction of 10% into 10 parts of raw meat by weight parts, rolling and rubbing the raw meat or pickling through pulse varying voltage, wherein the pickling temperature is 4 degree Celsius, and the pickling time is 3-12 h.

Preferably, the thawing method includes thawing the raw meat at 4 degree Celsius for 24 h or performing variable temperature thawing at low temperature and high humidity for 6-24 h.

The present invention includes at least the following advantages:

1. In the method of the present invention, the cooking, drying and roasting process is used reasonably for roasting. The center temperature of the raw meat during cooking and the surface temperature during roasting are monitored in real time, which lays a foundation for the standardization and industrial production of roast meat. It is beneficial to achieve low consumption, low emission and low harmful content on the basis of ensuring the flavor of the roast meat, reduce production cost and improve product quality.

2. The present invention is simple and easy to implement, and is basically applicable to all the equipments combining cooking and roasting, which can use of boiled or cooked and dried in a smoked cooking stove, and any kind of roasting method such as traditional charcoal roasting, infrared electric roasting, gas roasting, far-infrared light wave roasting and superheated steam roasting. The method can maximize the application efficiency of the equipment on the basis of maintaining the traditional quality.

Other advantages, objects, and features of the present invention will be showed in part through following description, and in part will be understood by those skilled in the art from study and practice of the present invention.

### DETAILED DESCRIPTION

The present invention will now be described in further detail with reference to the accompanying drawings in order to enable person skilled in the art to practice with reference to the description.

It should be noted that terms of “having”, “containing” and “including” as used herein do not exclude presence or addition of one or more other elements or combinations thereof.

The present invention provides a roasting method for meat based on temperature, including the following steps of:

cooking: cooking the pretreated raw meat to center temperature of 70-80 degree Celsius, and maintaining for 1-2 min;

drying: performing drying treatment of the surface of the raw meat after cooking treatment;

roasting: roasting dried raw meat to a surface temperature of 110-120 degree Celsius and maintaining for 5-8 min.

In the roasting method for meat based on temperature, the pretreated raw meat is cooked to a meat with center temperature of 75 degree Celsius, and maintaining for 1 min.

In the roasting method for meat based on temperature, the roasting temperature is 200-260 degree Celsius, roasting the dried raw meat to a surface temperature of 110-120 degree Celsius and maintaining for 5 min.

In the roasting method for meat based on temperature, the roasting temperature is 240 degree Celsius, roasting dried raw meat to a surface temperature of 115 degree Celsius and maintaining for 5 min.

In the roasting method for meat based on temperature, the method may use any roasting method, preferably using a far-infrared light wave to roast the raw meat.

In the roasting method for meat based on temperature, the drying temperature of the cooked raw meat in the drying treatment is 25-70 degree Celsius, the weight of the meat being reduced by 1-3% and then maintaining for 1-3 min, so that there is no dripping water on the surface of the meat.

In the roasting method for meat based on temperature, the specific method of the pretreatment includes:

washing fresh raw meat or thawed raw meat with water to remove residual blood and dirt;

injecting I part of salt solution with mass fraction of 10% into 10 parts of raw meat by weight parts, rolling and rubbing the raw meat or pickling through pulse varying voltage, wherein the pickling temperature is 4 degree Celsius, and the pickling time is 3-12 h.

In the roasting method for meat based on temperature, the thawing method includes thawing the raw meat at 4 degree Celsius for 24 h or performing variable temperature thawing at low temperature and high humidity for 6-24 h.

Roasting of meat according to the above method, and examining and evaluating the quality of the obtained roast meat.

### Embodiment 1

Selecting back mutton as raw material, preparing as the following steps:

The roasting method for meat based on temperature is summarized as a process of cooking-drying-roasting with infrared light wave, and the specific steps including:

Step One: Pretreatment

Performing pretreatment, taking out the mutton samples in a −20 degree Celsius cold storage, and thawing at 4 degree Celsius for 24 h; washing the thawed mutton with water to remove residual blood and dirt; injecting salt solution with mass fraction of 10% into raw meat according to a mass ratio of 1:10, rolling and rubbing the raw meat or pickling at 4 degree Celsius fix 6 h.

Step Two: Roasting Process

After the pickling process is completed, performing roasting process by a process of cooking-drying-roasting with far infrared light wave. After the water in the steamer is boiled, the pickled mutton is added and cooked at 100 degree Celsius, so that the center temperature of the meat reaches 65 degree Celsius, 70 degree Celsius, 75 degree Celsius, 80 degree Celsius, 85 degree Celsius, respectively, maintaining for 1 min, drying at 60% relative humidity for 1 min, roasting in a far-infrared light wave oven at 240 degree Celsius for 5 min, so that the surface is browned, cooling the roast meat to room temperature, and performing sensory evaluation. The results of the sensory evaluation are shown in Table 1 (the effect of different center temperatures during cooking on the quality of the roast meat).

TABLE 1
Sensory evaluation scores for different cooking temperatures

| Sensory | Sensory evaluation scores | | | | |
|---|---|---|---|---|---|
| index | 65° C. | 70° C. | 75° C. | 80° C. | 85° C. |
| Surface | 8.0 ± 1.2^{a} | 6.8 ± 0.8^{bc} | 8.6 ± 1.2^{a} | 7.6 ± 1.4^{ab} | 6.2 ± 0.8^{c} |
| color | | | | | |
| Surface | 6.4 ± 1.6^{b} | 8.0 ± 1.0^{a} | 8.4 ± 1.0^{a} | 6.8 ± 1.2^{b} | 7.6 ± 1.6^{a} |
| smell | | | | | |
| Surface | 7.6 ± 1.0^{a} | 6.4 ± 1.4^{b} | 6.4 ± 1.0^{b} | 6.8 ± 1.1^{b} | 7.8 ± 1.0^{a} |
| crispness | | | | | |
| Meat | 7.6 ± 0.6^{a} | 6.2 ± 1.8^{b} | 8.4 ± 1.5^{a} | 7.8 ± 0.6^{a} | 8.0 ± 0.9^{a} |
| flavor | | | | | |
| Roast | 8.0 ± 0.3^{a} | 7.8 ± 0.8^{a} | 8.6 ± 0.5^{a} | 8.0 ± 1.0^{a} | 8.2 ± 1.1^{a} |
| flavor | | | | | |
| Gamy odor | 7.2 ± 0.5^{b} | 7.8 ± 1.2^{a} | 7.8 ± 1.1^{a} | 8.4 ± 0.8^{a} | 7.8 ± 1.1^{b} |
| Mouth feel | 6.4 ± 0.7^{b} | 7.2 ± 1.0^{b} | 8.0 ± 0.8^{a} | 6.4 ± 1.2^{b} | 5.4 ± 1.2^{c} |
| Juiciness | 6.4 ± 1.2^{a} | 5.2 ± 0.9^{a} | 6.4 ± 1.2^{a} | 5.2 ± 0.7^{a} | 5.6 ± 1.2^{a} |
| Overall | 7.2 ± 1.2^{a} | 5.6 ± 0.8^{b} | 8.0 ± 1.2^{a} | 6.2 ± 1.1^{b} | 6.2 ± 1.1^{b} |
| acceptability | | | | | |

Note:
the different letters in the table indicate significant differences, and P is less than 0.05.

As shown in Table 1, the overall acceptability score of the roast meat was the highest at the center temperature of 75 degree Celsius during cooking process, which was not significantly different from 65 degree Celsius (P is more than 0.05), and was significantly different from 70 degree Celsius, 80 degree Celsius, and 85 degree Celsius (P is less than 0.05), but the safest minimum temperature for meat products is above 72 degree Celsius. The center temperature of 75 degree Celsius is the optimum cooking end temperature.

### Embodiment 2

Selecting back mutton as raw material, preparing as the following steps:

The roasting method for meat based on temperature is sun as a process of cooking-drying-roasting with infrared light wave, and the specific steps including:

Step one: pretreatment is same as the Embodiment 1.

Step Two: Roasting Process

After the pickling process is completed, performing roasting process by a process of cooking-drying-roasting through far infrared light wave, cooking at 100 degree Celsius until the center temperature of the pretreated raw meat reaches 75 degree Celsius, and maintaining for 1 min, drying at 25-70 degree Celsius and 60-70% relative humidity for 1-3 minutes so that there is no dripping water on the surface of the meat (the weight is reduced by 1-3%), roasting at 240 degree Celsius, and detecting the surface temperature of the meat by an infrared temperature detector. The surface temperature was 95 degree Celsius, 100 degree Celsius, 105 degree Celsius, 115 degree Celsius, 120 degree Celsius, respectively, maintaining for 5 min, performing sensory evaluation after cooling to room temperature. The results are shown in Table 2 (roast meat quality after roasting to different surface temperatures for 5 min).

TABLE 2
Sensory evaluation scores for different roasting surface temperature

| Sensory | Sensory evaluation scores | | | | |
|---|---|---|---|---|---|
| index | 95° C. | 100° C. | 105° C. | 115° C. | 125° C. |
| Surface | 7.2 ± 1.2^{a} | 7.8 ± 0.9^{a} | 7.4 ± 0.8^{a} | 8.4 ± 0.6^{a} | 7.4 ± 1.2^{a} |
| color | | | | | |
| Surface | 6.8 ± 0.9^{a} | 7.4 ± 1.0^{a} | 7.8 ± 1.0^{a} | 8.6 ± 0.8^{a} | 8.8 ± 0.5^{a} |
| smell | | | | | |
| Surface | 6.8 ± 1.2^{a} | 7.2 ± 1.0^{a} | 7.2 ± 1.0^{a} | 8.0 ± 1.2^{a} | 8.4 ± 0.8^{a} |
| crispness | | | | | |
| Meat | 7.6 ± 0.9^{a} | 6.8 ± 1.1^{a} | 6.8 ± 1.1^{a} | 8.4 ± 0.8^{a} | 8.0 ± 0.8^{a} |
| flavor | | | | | |
| Roast | 7.2 ± 1.0^{a} | 7.8 ± 1.2^{a} | 7.6 ± 0.8^{a} | 8.0 ± 0.8^{a} | 7.6 ± 1.4^{a} |
| flavor | | | | | |
| Gamy odor | 7.4 ± 1.6^{a} | 7.4 ± 1.2^{a} | 7.6 ± 1.0^{a} | 8.0 ± 0.8^{a} | 7.6 ± 0.8^{a} |
| Mouth feel | 7.6 ± 1.1^{a} | 7.4 ± 0.9^{a} | 7.6 ± 1.1^{a} | 8.4 ± 0.6^{a} | 7.6 ± 0.8^{a} |
| Juiciness | 8.4 ± 0.6^{a} | 7.6 ± 1.2^{a} | 7.6 ± 0.9^{a} | 7.4 ± 0.8^{a} | 7.0 ± 1.0^{a} |
| Overall | 6.4 ± 1.2^{a} | 6.8 ± 1.0^{a} | 6.8 ± 1.0^{a} | 8.0 ± 0.8^{a} | 7.2 ± 1.2^{a} |
| acceptability | | | | | |

Note:
the different letters in the table indicate significant differences, and P is less than 0.05.

As shown in Table 2, the overall acceptability score of the roast meat was the highest at the roasting surface temperature of 115 degree Celsius, which was not significantly different from 125 degree Celsius (P is more than 0.05), and was significantly different from 95 degree Celsius, 100 degree Celsius, and 105 degree Celsius (P is less than 0.05). In order to save energy, the roasting surface temperature is preferably 115 degree Celsius.

### Embodiment 3

Selecting back mutton as raw material, preparing as the following steps:

The roasting method for meat based on temperature is summarized as a process of cooking-drying-roasting with infrared light wave, and the specific steps including:

Step One: Pretreatment

Performing pretreatment, taking out the mutton samples in a −20 degree Celsius cold storage, and thawing at 4 degree Celsius for 24 h, washing the thawed mutton with water to remove residual blood and dirt; injecting salt solution with mass fraction of 10% into the raw meat according to a mass ratio of 1:10, rolling and rubbing the raw meat or pickling at 4 degree Celsius for 6 h.

Step Two: Roasting Process

After the pickling process is completed, performing roasting process by a process of cooking-drying-roasting through far infrared light wave. After the water in the steamer is boiled, the pickled mutton is added, so that the center temperature of the meat reaches 75 degree Celsius, maintaining for 1 min, taking out, drying at 35-55 degree Celsius and 60-70% relative humidity for 1-3 min so that there is no dripping water on the surface of the meat (the weight is reduced by 1-3%), roasting in a far-infrared light wave oven at 240 degree Celsius, maintaining for 5 min when the surface temperature of the meat reaches 115 degree Celsius, so that the surface of the roast meat is browned.

Step Three: Packing

Cooling at room temperature for 20 min after roasting, and performing vacuum-packing.

### Embodiment 4 (Comparative Example 1)

Taking roasting method with an electric oven as an example, collecting the mutton roasted with the electric oven as a control sample. The roasting temperature was 180 degree Celsius recommended for the electric oven, and the roasting time was 40 min.

### Embodiment 5 (Comparative Example 2)

Taking roasting method with charcoal fire as an example, collecting the mutton roasted with the charcoal fire as a control sample. The roasting mode was roasting with charcoal fire, and the roasting time was 25 min.

The effect of different roasting processes on the color of roast mutton is shown in Table 3.

TABLE 3
L* value of surface color of roasted mutton
in different roasting processes

| Sample | L* |
|---|---|
| Comparative Example 1 (Embodiment 4) | 44.18 ± 2.30^{a} |
| Comparative Example 2 (Embodiment 5) | 34.11 ± 1.76^{b} |
| Embodiment 3 | 35.41 ± 1.64^{b} |

Note:
the different letters in the table indicate significant differences, and P is less than 0.05.

The effect of different roasting processes on the color of roast mutton is shown in Table 4.

TABLE 4
a* value of surface color of roasted mutton
in different roasting processes

| Sample | a* |
|---|---|
| Comparative Example 1 (Embodiment 4) | 3.87 ± 0.08^{b} |
| Comparative Example 2 (Embodiment 5) | 8.06 ± 1.37^{a} |
| Embodiment 3 | 7.18 ± 0.73^{a} |

Note:
the different letters in the table indicate significant differences, and P is less than 0.05.

As shown in Table 3 and Table 4, the embodiment 3 is the roasting method for meat based on temperature according to the present invention, which uses the process of cooking-drying-roasting with infrared light wave. The comparative example 1 is roast meat roasted using electric oven. The comparative example 2 is roast meat roasted using charcoal fire. The difference of the brightness value L* of the roast meat between the embodiment 3 and comparative example 1 was significant (P is less than 0.05), and the difference with the comparative example 2 was not significant (P is more than 0.05). The difference of the redness value a* of the roast meat between the embodiment 3 and comparative example 1 was significant (P is less than 0.05), and the difference with the comparative example 2 was not significant (P is more than 0.05), which indicated that the roasting method of the embodiment 3 maintained the attractive color of the conventional charcoal fire roast and improved the color of roast meat roasted with the electric oven used in the factory. It can be seen that the the roasting method for meat based on temperature according to the present invention can effectively maintain the attractive color of the traditional charcoal roasting and enhance the color quality of the product.

The sensory evaluation of roast meat through different roasting process is shown in Table 5.

The embodiment 3 is the roasting method for meat based on temperature according to the present invention, which uses the process of cooking-drying-roasting with infrared light wave. The comparative example 1 is roast meat roasted using electric oven. The comparative example 2 is roast eat roasted using charcoal fire. Sensory evaluation results show that the overall acceptability of the roast meat of the embodiment 3 and comparative example 1 is significantly different (P is less than 0.05). and the difference with the comparative example 2 was not significant (P is more than 0.05), which indicated that the roasting method of the embodiment 3 maintained the good flavor of the conventional charcoal fire roasting, and improved the public acceptability of roast meat roasted with the electric oven used in the factory. It shows that the application of this method can significantly improve the acceptability of industrialized processing roast meat and maintain the good taste and flavor of the sample. It can be seen that the the roasting method for meat based on temperature according to the present invention can effectively maintain the good flavor of the traditional charcoal roasting and enhance the flavor quality of the product.

TABLE 5
Sensory evaluation scores for roast meat
through different roasting process

| | | Comparative | Comparative |
|---|---|---|---|
| Sensory | | Example 1 | Example 2 |
| evaluation | Embodiment 1 | (Embodiment 4) | (Embodiment 5) |
| Color | 6.4 ± 1.1^{a} | 6.4 ± 0.9^{a} | 6.0 ± 2.8^{a} |
| Crispness | 7.2 ± 1.3^{a} | 5.0 ± 1.0^{b} | 5.8 ± 1.5^{b} |
| Smell | 8.0 ± 0.7^{a} | 5.0 ± 1.2^{bc} | 6.2 ± 1.5^{ab} |
| Meat | 8.2 ± 0.4^{a} | 6.2 ± 1.3^{b} | 7.6 ± 0.5^{a} |
| flavor | | | |
| Roast | 8.2 ± 0.4^{a} | 6.0 ± 1.7^{b} | 8.2 ± 0.4^{a} |
| flavor | | | |
| Gamy odor | 8.4 ± 0.5^{a} | 5.4 ± 0.8^{b} | 7.6 ± 1.3^{a} |
| Mouth feel | 8.0 ± 0.7^{a} | 5.8 ± 1.9^{b} | 7.8 ± 1.6^{a} |
| Taste | 7.8 ± 0.8^{a} | 5.6 ± 0.5^{b} | 7.8 ± 1.6^{a} |
| Overall | 8.0 ± 0.7^{a} | 4.2 ± 0.8^{b} | 7.8 ± 1.3^{a} |
| acceptability | | | |

Note:
the different letters in the table indicate significant differences, and P is less than 0.05.

Although the embodiments of the present invention have been disclosed above, they are not limited to the applications previously mentioned in the specification and embodiments, and can be applied in various fields suitable for the present invention. For ordinary skilled person in the field, other various changed model, formula and parameter may be easily achieved without creative work according to instruction of the present invention, changed, modified and replaced embodiments without departing the general concept defined by the claims and their equivalent are still included in the present invention. The present invention is not limited to particular details and illustrations shown and described herein.

What is claimed is:

1. A roasting method for meat based on temperature, being characterized in that, includes:
cooking: cooking the pretreated raw meat to center temperature of 70-80 degree Celsius, and maintaining for 1-2 min;
drying: performing drying treatment of the surface of the raw meat after cooking treatment;
roasting: roasting the dried raw meat to surface temperature of 110-120 degree Celsius and maintaining for 5-8 min.

2. The roasting method for neat based on temperature according to claim 1, being characterized in that, the pretreated raw meat is cooked to center temperature of 75 degree Celsius, and maintained for 1 min.

3. The roasting method for meat based on temperature according to claim 1, being characterized in that, the roasting temperature is 200-260 degree Celsius, roasting the dried raw meat to surface temperature of 110-120 degree Celsius and maintaining for 5 min.

4. The roasting method for meat based on temperature according to claim 1, being characterized in that, the roasting temperature is 240 degree Celsius, roasting the dried raw meat to surface temperature of 115 degree Celsius and maintaining for 5 min.

5. The roasting method for meat based on temperature according to claim 1, being characterized in that, the raw meat is roasted through a far-infrared light wave method.

6. The roasting method for meat based on temperature according to claim 1, being characterized in that, the drying temperature of the cooked raw meat in the drying treatment is 25-70 degree Celsius, the weight of the meat being reduced by 1-3% and then maintaining for 1-3 min, so that there is no dripping water on the surface of the meat.

7. The roasting method for meat based on temperature according to claim 1, being characterized in that, the specific method of the pretreatment includes:
washing fresh raw meat or thawed raw meat with water to remove residual blood and dirt;
injecting 1 part of salt solution with mass fraction of 10% into 10 parts of the raw meat by weight parts, rolling and rubbing the raw meat or pickling through pulse varying voltage, wherein the pickling temperature is 4 degree Celsius, and the pickling time is 3-12 h.

8. The roasting method for meat based on temperature according to claim 1, being characterized in that, the thawing method includes thawing the raw meat at 4 degree Celsius for 24 h or performing variable temperature thawing at low temperature and high humidity for 6-24 h.
